(19) United States
(12) Patent Application Publication
(10) Pub. No.: US 2006/0021191 A1
(43) Pub. Date: Feb. 2, 2006

(54) Buffering device for a door

(76) Inventor: Wen-Shown Huang, Taichung (TW)

Correspondence Address: BINGHAM, MCCUTCHEN LLP, THREE EMBARCADERO CENTER, 18 FLOOR, SAN FRANCISCO, CA, 94111-4067, US

(21) Appl. No.: 11/240,377

(22) Filed: Oct. 3, 2005

Related U.S. Application Data
(63) Continuation-in-part of application No. 10/805,511, filed on Mar. 22, 2004.

(51) Int. Cl. E05F 5/02

(52) U.S. Cl. 16/82

(57) ABSTRACT

A buffering device for a door has a holding body and an insert body. The holding body is mounted on a wall by a fastener and has a holding hole and through hole. The holding hole is communicated with the through hole. The insert body is mounted on the door and inserted into the holding hole in the holding body when the door is opened. The holding body is made of a material different from that of the insert body. One of the holding body and the insert body is made of a soft material.

The present invention is a continuation-in-parts of application Ser. No. 10/805,511, filed on Mar. 22, 2004.

### BACKGROUND OF THE INVENTION

1. Field of Invention The present invention relates to a buffering device, more particularly to a buffering device for a door.

2. Description of the Related Art

With reference to FIG. 7, a conventional buffering device for a door is mounted on rear surface of the bottom rail of the door. The buffering device is used for preventing the door from banging into the wall when the door is swung open too quickly, and for also holding the door open.

The conventional buffering device for a door (50) has a holding body (90) and an impact body (94). The holding body (90) is mounted on a wall (60) and has a first base (91), a head (93) and a magnet (92). The first base (91) has a top surface (not numbered) and a bottom surface (not numbered). The bottom surface of the base (91) is mounted on the wall (60). The head (93) is integrally formed on the top surface of the base (91) and has a top surface (not numbered). The magnet (92) is mounted on the top surface of the head (93).

The impact body (94) is mounted on a rear surface of the door (50) at an outside corner and has a received head (not numbered) and a second base (not numbered). The second base has a top surface (not numbered) and a bottom surface (not numbered). The bottom surface of the second base is mounted on the rear surface of the door (50) and the received head is integrally formed on the top surface of the second base.

When the door (50) is opened, the impact body (94) is aligned with the holding body (90). The magnet (92) on the holding body (90) contacts the impact body (94) and makes the door become held well and prevents the door from closing again. However, the buffering device for a door has the following disadvantages.

1. The structure of the buffering device is complex. The shapes of holding body (90) and the impact body (94) are different, and the holding body (90) and the impact body (94) must be made respectively. The way to form the holding body (90) and the impact body (94) is inconvenient and expensive.

2. The conventional buffering device will make a loud noise. The conventional holding body (90) and the impact body (94) are made of a hard material, such that when the magnet (92) contacts the impact body (94), the conventional buffering device will make a loud noise.

3. The conventional buffering device is made of a hard material that is easily broken after using a period of time, or when the door is often swung open wildly. Furthermore, the magnet (92) on the holding body (90) is easily separated from the holding body.

4. The conventional buffering device is not versatile in use. The conventional buffering device can only fit with a door that is substantially parallel to a wall, with further reference to FIG. 8, but cannot fit with a door that is not parallel to a wall.

In addition, U.K. Patent No. GB 2,075,117 discloses a conventional door stop comprising a male piece and a female piece corresponding to the male piece. However, because the male and female pieces of the '117 Patent are both made of resilient material, any one of the male and female pieces are easily deformed to cause the combination of the male and female pieces to fail. In addition, the door stop of the '117 patent can only fit with a door that is substantially parallel to a wall, but cannot fit with a door that is not parallel to a wall. Therefore, the conventional door stop of the '117 Patent is not versatile in use.

Another conventional wall-bump is disclosed in U.S. Pat. No. 6,295,697 to Simon. However, the wall-bump of the '697 patent also can only fit with a door that is substantially parallel to a wall, but cannot fit with a door that has an angle relative to a wall. Therefore, the conventional wall-bump of the '697 patent is not versatile in use.

The present invention provides a buffering device for a door to mitigate or obviate the aforementioned problems.

### SUMMARY OF THE INVENTION

An objective of the present invention is to provide a buffering device for a door that has a simple structure, is relatively quiet in operation and is versatile in use.

To achieve the objective, the buffering device for a door has a holding body and an insert body. The holding body is mounted on a wall by a fastener and has a holding hole and through hole. The holding hole is communicated with the through hole. The insert body is mounted on the door and inserted into the holding hole in the holding body when the door is opened. The holding body is made of a material different from that of the insert body. One of the holding body and the insert body is made of a soft material.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a buffering device for a door in accordance with the present invention which is mounted on a wall and a door;

FIG. 2 is an exploded perspective view of the buffering device for a door in FIG. 1;

FIG. 3 is a side plan view in partial section of the buffering device for a door in FIG. 1;

FIG. 4 is a side plan operational view in partial section of the buffering device for a door in FIG. 1;

FIG. 5 is a side plan view in partial section of another embodiment of a buffering device in accordance with the present invention;

FIG. 6 is an operational top plan view of the buffering device in FIG. 5;

FIG. 7 is a perspective view of a conventional buffering device for a door in accordance with the prior art; and

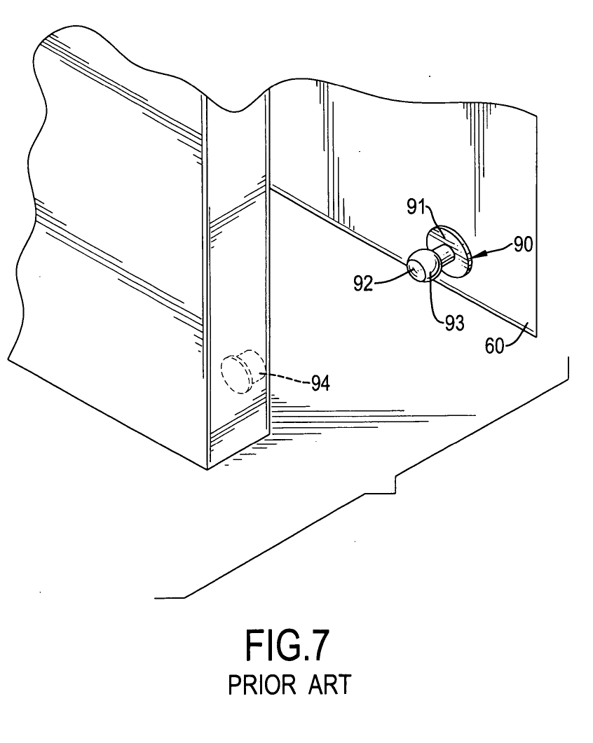

FIG. 8 is an operational top plan view of a conventional buffering device in FIG. 7.

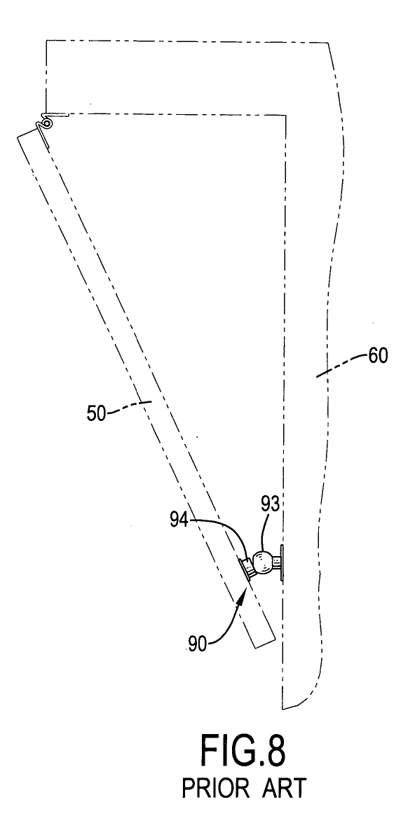

### DETAILED DESCRIPTION OF THE INVENTION

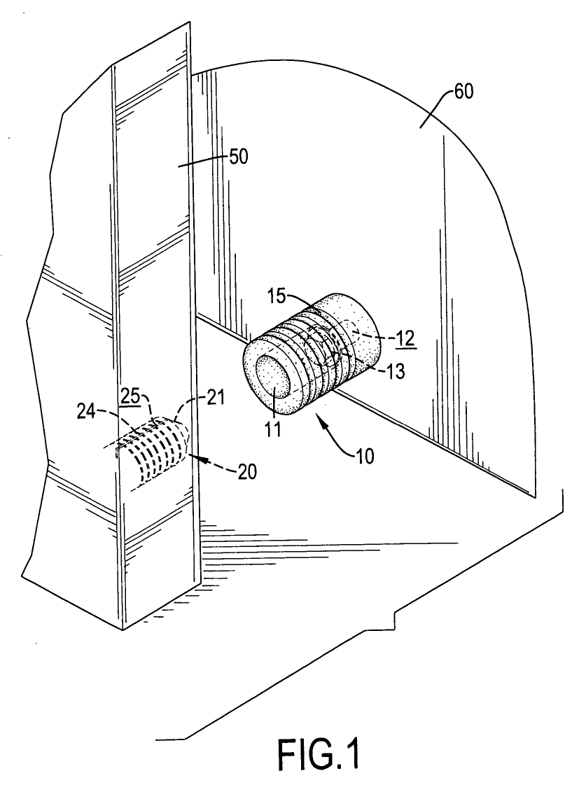

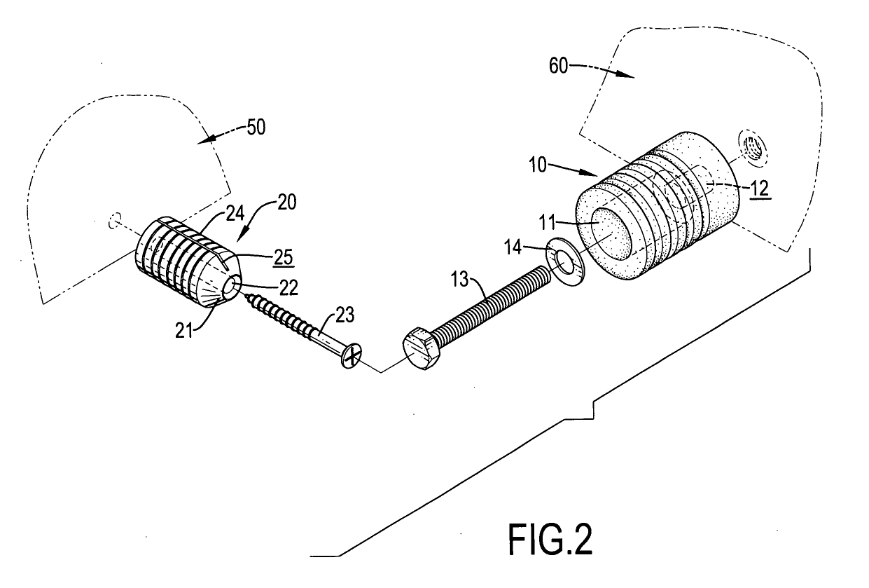

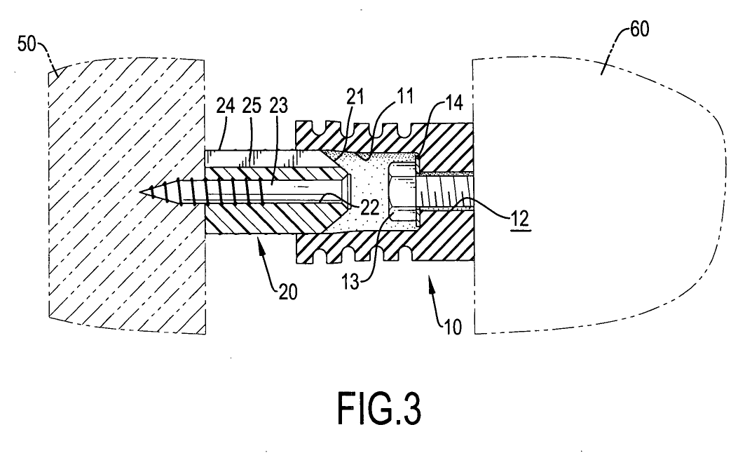

With reference to FIGS. 1 to 3, a buffering device for a door in accordance with the present invention has a holding body (10) and an insert body (20).

The holding body (10) is mounted on a wall (60) and made of a hard plastic material or a soft material. The holding body (10) has an inner end, an outer end, an outer surface, a holding hole (11), a through hole (12), a fastener, a washer (14) and multiple optional recesses (15). The inner end of the holding body (10) is mounted on the wall (60). The holding hole (11) is defined in the holding body (10) from the outer end and the through hole (12) is defined in the holding body (10) from the inner end. The holding hole (11) has a diameter and the through hole (12) also has a diameter. The holding body (11) is communicated with the through hole (12) and the diameter of the holding body (11) is larger than the diameter of the through hole (12). The washer (14) is mounted inside the holding hole (11). In a preferable embodiment, the fastener is a bolt (13) with a threaded body and head at one end of the body. The bolt (13) is mounted in the holding body (10) through the holding hole (11) such that the head clamps the washer (14) and holding body against the wall (60) as the threaded end threadingly penetrates the wall (60) via the through hole (12). The holding hole (11) can be formed in one of many shapes. The multiple optional recesses (15) are defined on the outer surface of the holding body (10) near the outer end.

The insert body (20) is mounted on a door (50) and has an inner end, a conical outer end (21), an outer surface, a longitudinal hole (22), a screw (23), multiple optional protruding rings (24) and an optional slit (25). The insert body (20) is adapted to be mounted on a door (50) and made of a hard plastic material or a soft material but different from that of the holding body (10). One of the holding body (10) and the insert body (20) is made of a hard plastic material with a hardness larger than that of the other that is made of a soft material. The inner end of the insert body (20) is mounted on the door (50). The conical outer end (21) can easily insert into the holding hole (11) in the holding body (10) when the door (50) is opened. The longitudinal hole (22) is defined through the insert body (20) from the outer end to the inner end. The screw (23) is inserted into the longitudinal hole (22) and fixed inside the door (50). The protruding rings (24) are formed on the outer surface of the insert body (20) and are used for preventing the insert body (20) from slipping out from the holding body (10). The optional slit (25) is longitudinally defined in the outer surface of the insert body (20) and is used for allowing air to escape when the insert body (20) is inserted inside the holding body (10).

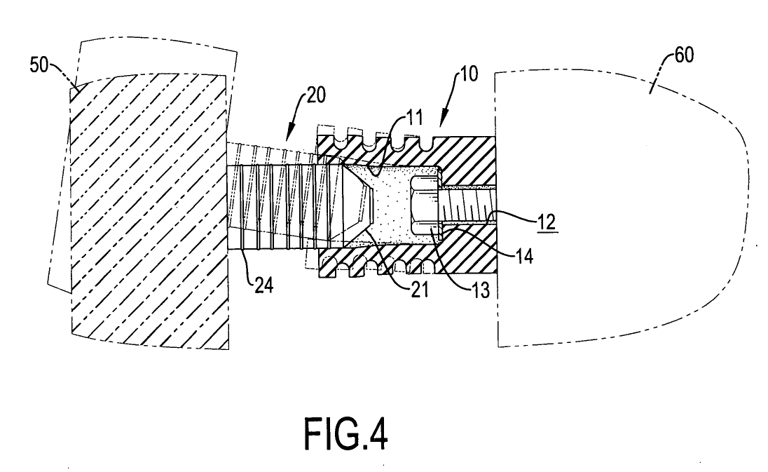

With reference to FIG. 4, when the door (50) is opened to a maximum extent and if the insert body (20) can not insert the holding hole (11) precisely, the multiple recesses (15) provide the holding body (10) with elastic deformation to still receive the insert body (20).

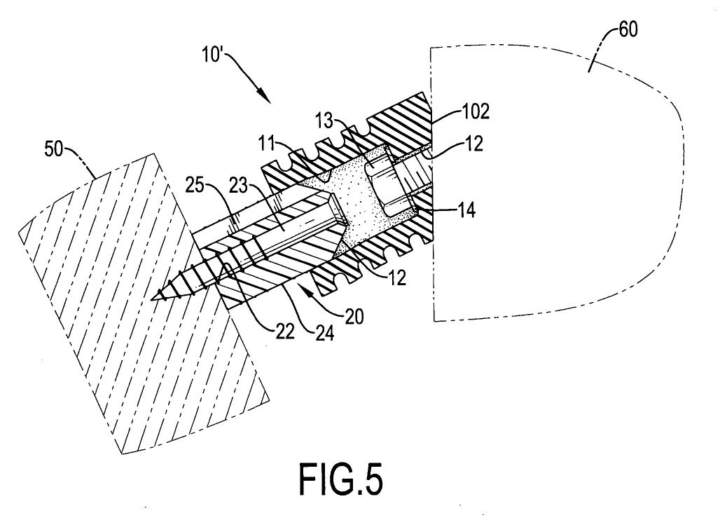

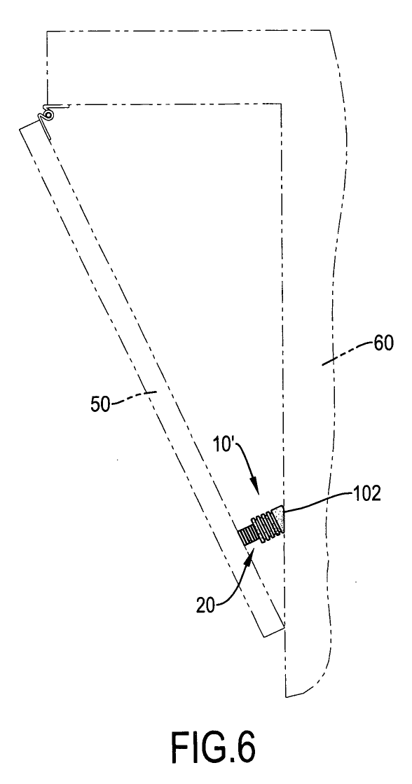

With reference to FIGS. 5 and 6, the holding body (10′) may further have an inclined surface (102) defined in the inner end. With the arrangement of the inclined surface (102), the angle between the holding body (10′) and the wall (60) is changed. Accordingly, the buffering device can fit with a door (50) that has an angle relative to a wall (60) and is versatile in use.

The buffering device for a door in accordance with the present invention has the following advantages.

1. Low cost simplicity.—The structure of the buffering device for a door in accordance with the present invention is simple. The holding body (10) and the insert body (20) are directly made by plastic injection molding, so that the way to form the holding body (10) and the insert body (20) is simpler than the conventional ones and the cost will accordingly be reduced.

2. Low noise operation.—One of the holding body (10) and the insert body (20) is made of a soft material, such that when the door is swung open too quickly, the buffering device made of the soft material will not make a loud noise.

3. Long use life.—One of the holding body (10) and the insert body (20) of the buffering device for a door in accordance with the present invention is made of a soft material, when a door is opened with too great a force, the buffering device will not easily be broken and provides a long term use.

4. Not easy deformation.—Because one of the holding body (10) and the insert body (20) is made of a hard plastic material, deformation of the holding body (10) and the insert body (20) can be prevented to ensure the combination of the bodies (10,20).

5. Versatile in use.—With the arrangement of the inclined surface (102) in the holding body (10), the buffering device in accordance with the present invention can fit with different types of doors by changing the inclined angle of the inclined surface (102). Therefore, the buffering device in accordance with the present invention is versatile in use.

The invention may be varied in many ways by a person skilled in the art. Such variations are not to be regarded as a departure from the spirit and scope of the invention, and all such modifications are intended to be included within the scope of the following claims.

What is claimed is:

1. A buffering device for a door having
a holding body having
an inner end,
an outer end,
an outer surface,
a holding hole defined in the holding body and extending from the outer end and having a diameter,
a through hole defined in the holding body and extending from the inner end and communicated with the holding hole, having a diameter,
a washer mounted inside the holding hole, and
a fastener mounted through the holding hole and the washer to clamp the holding body to a wall, and
an insert body corresponding to and selectively inserted into the holding hole in the holing body, adapted to be mounted on the door and having
a rear surface receivable in the holding hole in the holding body when the door is appropriately opened,
an inner end adapted to be mounted on a rear surface of the door,
an outer end,
an outer surface,
a longitudinal hole defined through the insert body from the outer end to the inner end, and
a screw inserted into the longitudinal hole to secure the insert body to the rear surface of the door,
wherein the holding body is made of a material different from that of the insert body; and
one of the holding body and the insert body is made of a hard plastic material with a hardness larger than that of the other that is made of a soft material.

2. The buffering device for a door as claimed in claim 1, wherein the insert body further comprises a slit longitudinally defined in the outer surface of the insert body.

3. The buffering device for a door as claimed in claim 2, wherein the holding body further comprises multiple recesses defined in the outer surface near the outer end.

4. The buffering device for a door as claimed in claim 3, wherein the insert body further comprises multiple protruding rings formed on the outer surface of the insert body.

5. The buffering device for a door as claimed in claim 4, wherein the holding body further has an inclined surface formed on the inner end.

6. The buffering device for a door as claimed in claim 1, wherein the insert body and the holding body are made of plastic material.

7. The buffering device for a door as claimed in claim 1, wherein the diameter of the holding hole is larger than the diameter of the through hole.

8. The buffering device for a door as claimed in claim 1, wherein the holding body further has an inclined surface formed on the inner end.
